(19) United States
(12) Patent Application Publication
(10) Pub. No.: US 2012/0196197 A1
(43) Pub. Date: Aug. 2, 2012

(54) FUEL CELL SYSTEM AND METHOD FOR CONTROLLING THE SAME

(75) Inventors: Chin-Hao Wu, Hsinchu County (TW); Kuo-Tai Hung, Hsinchu County (TW)

(73) Assignee: YOUNG GREEN ENERGY CO., HSINCHU COUNTY (TW)

(21) Appl. No.: 13/352,343

(22) Filed: Jan. 18, 2012

(30) Foreign Application Priority Data
Jan. 27, 2011 (CN) 201110032658.7

(51) Int. Cl. H01M 8/04

(52) U.S. Cl. 429/429; 429/432; 429/431

(57) ABSTRACT

A method for controlling a fuel cell system includes following steps. It is determined whether an output voltage of a fuel cell stack in the fuel cell system is greater than or equal to a temporary voltage during a first predetermined period, and if yes, an output current of the fuel cell stack is progressively increased during a second predetermined period, and if not, when a variation degree of the output voltage of the fuel cell stack is greater than a predetermined value, the output current of the fuel cell stack is progressively decreased during the second predetermined period. The output voltage of the fuel cell stack is changed in response to progressive increasing or progressive decreasing of the output current of the fuel cell stack, and the temporary voltage is updated to the changed output voltage after a third predetermined period.

### CROSS-REFERENCE TO RELATED APPLICATION

This application claims the priority benefit of China application serial no. 201110032658.7, filed on Jan. 27, 2011. The entirety of the above-mentioned patent application is hereby incorporated by reference herein and made a part of this specification.

### BACKGROUND

1. Field of the Invention

The invention relates to a fuel cell system and a method for controlling the same. Particularly, the invention relates to a fuel cell system capable of increasing a fuel utilization rate and having a protection function, and a method for controlling the same.

2. Description of Related Art

Development and application of energy have always been indispensable conditions of human life, however, the development and application of energy may cause increasing damage to the environment. Energy generated through a fuel cell technique has advantages of high efficiency, low noise, and pollution-free, etc. which is an energy technology in line with a trend of the times. During an operation process of a fuel cell system, how to control an output voltage and an output current of a fuel cell stack to obtain a highest output power and make a full use of the fuel in the fuel cell stack for electric energy conversion have become major performance indexes of the fuel cell system.

Generally, the fuel cell stack has different working properties under different fuel supplying rates. Referring to FIG. 1, FIG. 1 is a diagram illustrating a current density-voltage curve of a fuel cell stack under different fuel supplying rates R1-R3 (R1>R2>R3). In case of the fuel supplying rate R2, an optimal operating point (V, I) of the fuel cell stack is an operating point OP2 (V2, I2). If the output current I of the fuel cell stack is set to be greater than the current I2, a phenomenon of insufficient fuel supply is occurred, and the output voltage V of the fuel cell stack is rapidly decreased, which may cause a damage of the fuel cell stack. Moreover, if the output current I of the fuel cell stack is set to be smaller than the current I2, a fuel utilization rate is decreased since a product (V×I) of the output voltage V and the output current I of the fuel cell is smaller than a product (V2×I2) of the voltage V2 and the current I2 corresponding to the optimal operating point OP2.

On the other hand, the fuel cell stacks with different aging degrees correspond to different working properties. Referring to FIG. 2, FIG. 2 is a diagram illustrating a current density-voltage curve of a fuel cell stack under different aging degrees A1-A3 (A3>A2>A1). In case of the aging degree A2 of the fuel cell stack, the optimal operating point (V, I) of the fuel cell stack is the operating point OP2 (V2, I2). When the output voltage V is set to be greater than the voltage V2, the fuel utilization rate is decreased, and if the output voltage V is set to be smaller than the voltage V2, the phenomenon of insufficient fuel supply is occurred, which may cause a damage of the fuel cell stack.

Moreover, referring to FIG. 3, FIG. 3 is a schematic diagram illustrating a voltage variation of a fuel cell stack switched between the operating points OP1-OP3.

When the operating point (V, I) of the fuel cell stack is switched from the operating point OP1 (V1, I1) to the operating point OP2 (V2, I2), a voltage variation thereof is ΔV. Now, since the operating point OP2 (V2, I2) still does not enter a fuel insufficient region, the voltage variation ΔV is relatively small. Moreover, when the operating point (V, I) of the fuel cell stack is switched from the operating point OP2 (V2, I2) to the operating point OP3 (V3, I3), a voltage variation is ΔV′. Now, since the operating point OP3 (V3, I3) enters the fuel insufficient region, the voltage variation ΔV′ is relatively great, and the variation is immense.

According to the above descriptions, in order to cope with different working properties of the fuel cell stack to improve working efficiency and achieve a purpose of cell protection, a correct operating point (V, I) of the fuel cell stack is required to be selected. However, according to the conventional technique, a constant voltage, a constant current or a voltage disturbance observation method is generally used to control the voltage and current operating point of the fuel cell stack. For example, according to a disclosure of U.S. Pat. No. 5,714,874, a constant voltage method is used for controlling an output voltage of a fuel cell stack between 27V and 28V, and according to a disclosure of U.S. Publication No. 2006/0029844, a voltage disturbance observation method is used to obtain a maximum output power point of a fuel cell stack.

However, the constant voltage control method is only adapted to a fuel cell system supplying a fixed fuel flow, which is not adapted to a fuel cell system with a varied fuel flow. When the constant voltage control method is applied to the fuel cell system with a varied fuel flow, in case of insufficient fuel or excessive fuel, a power generating efficiency of the fuel cell stack is relatively low. Moreover, when the constant voltage control method is applied to an aged fuel cell stack, since an operating point of the aged fuel cell stack is shifted, the fuel utilization rate is decreased accordingly. In addition, since the constant voltage control method is liable to cause immense variation of the output voltage and the output current of the fuel cell stack, a lifetime of the fuel cell stack is reduced.

Since the voltage disturbance observation method disclosed by the U.S. Publication No. 2006/0029844 does not set a low voltage protection point, the excessively low output voltage of the fuel cell stack may cause damage of the fuel cell stack. Moreover, during the operation, the output voltage of the fuel cell stack is required to be disturbed, the output voltage and the output current of the fuel cell stack may have immense variations, which may reduce the lifetime of the fuel cell stack.

Moreover, Taiwan Publication No. 200905960 and U.S. Publication No. 2007/0196700, 2007/0178336 and 2010/0173211 respectively disclose a control method of a fuel cell system.

### SUMMARY OF THE INVENTION

The invention is directed to a method for controlling a fuel cell system, by which an output voltage and an output current of a fuel cell stack in the fuel cell system could be stably adjusted, so that the fuel cell stack may have a higher output power, and fuel entering the fuel cell stack is able to be effectively used for electric energy conversion.

The invention is directed to a fuel cell system, which could stably work to maintain a high power generating efficiency and a longer lifetime of a fuel cell stack.

Additional aspects and advantages of the invention will be set forth in the description of the techniques disclosed in the invention.

To achieve one of or all aforementioned and other advantages, an embodiment of the invention provides a method for controlling a fuel cell system, which includes following steps. It is determined whether an output voltage of a fuel cell stack in the fuel cell system is greater than or equal to a temporary voltage during a first predetermined period, and if yes, an output current of the fuel cell stack is progressively increased during a second predetermined period, and if not, when a variation degree of the output voltage of the fuel cell stack is greater than a predetermined value, the output current of the fuel cell stack is progressively decreased during the second predetermined period. The output voltage of the fuel cell stack is changed in response to progressive increasing or progressive decreasing of the output current of the fuel cell stack, and the temporary voltage is updated to the changed output voltage after a third predetermined period.

In an embodiment of the invention, before the step of determining the output voltage of the fuel cell stack, the method further includes obtaining the output voltage of the fuel cell stack.

In an embodiment of the invention, before the step of obtaining the output voltage of the fuel cell stack, the method further includes performing a slow start procedure to make the fuel cell stack suitable for operation.

In an embodiment of the invention, when the variation degree of the output voltage of the fuel cell stack is smaller than the predetermined value, the output voltage of the fuel cell stack is re-obtained for determination.

An embodiment of the invention provides a fuel cell system including a fuel cell stack, a detection unit, a conversion unit, and a processing unit. The fuel cell stack is used for carrying out a chemical reaction to produce electric energy. The detection unit is coupled to the fuel cell stack for detecting an output voltage, and an output current of the fuel cell stack. The conversion unit is coupled to the fuel cell stack for converting the output voltage and the output current of the fuel cell stack. The processing unit is coupled to the detection unit and the conversion unit for determining whether the output voltage of the fuel cell stack is greater than or equal to a temporary voltage during a first predetermined period, and if yes, the processing unit controls the conversion unit to indirectly and progressively increase the output current of the fuel cell stack during a second predetermined period, and if not, when a variation degree of the output voltage of the fuel cell stack is greater than a predetermined value, the processing unit controls the conversion unit to indirectly and progressively decrease the output current of the fuel cell stack during the second predetermined period. The processing unit controls the conversion unit to indirectly change the output voltage of the fuel cell stack in response to progressive increasing or progressive decreasing of the output current of the fuel cell stack, and updates the temporary voltage to the changed output voltage after a third predetermined period.

In an embodiment of the invention, when the variation degree of the output voltage of the fuel cell stack is smaller than the predetermined value, the processing unit re-determines the output voltage of the fuel cell stack.

In an embodiment of the invention, the fuel cell stack is a proton exchange membrane fuel cell stack (PEMFC stack).

In an embodiment of the invention, the first predetermined period is greater than the second predetermined period and the third predetermined period, and the third predetermined period is greater than the second predetermined period.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of illustrating a current density-voltage curve of a fuel cell stack under different fuel supplying rates R1-R3.

FIG. 2 is a diagram illustrating a current density-voltage curve of a fuel cell stack under different aging degrees A1 -A3.

FIG. 3 is a schematic diagram illustrating a voltage variation of a fuel cell stack switched between the operating points OP1-OP3.

FIG. 4 is a block diagram of a fuel cell system according to an embodiment of the invention.

FIG. 5 is a schematic diagram illustrating determination and update processes of a processing unit according to an embodiment of the invention.

FIG. 6 is a flowchart illustrating a method for controlling a fuel cell system according to an embodiment of the invention.

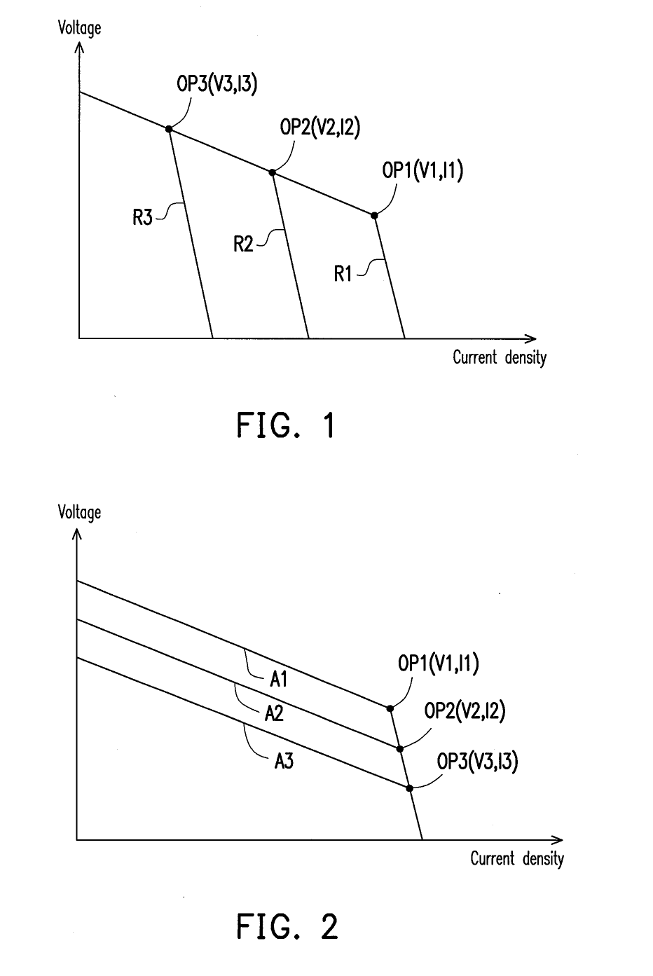

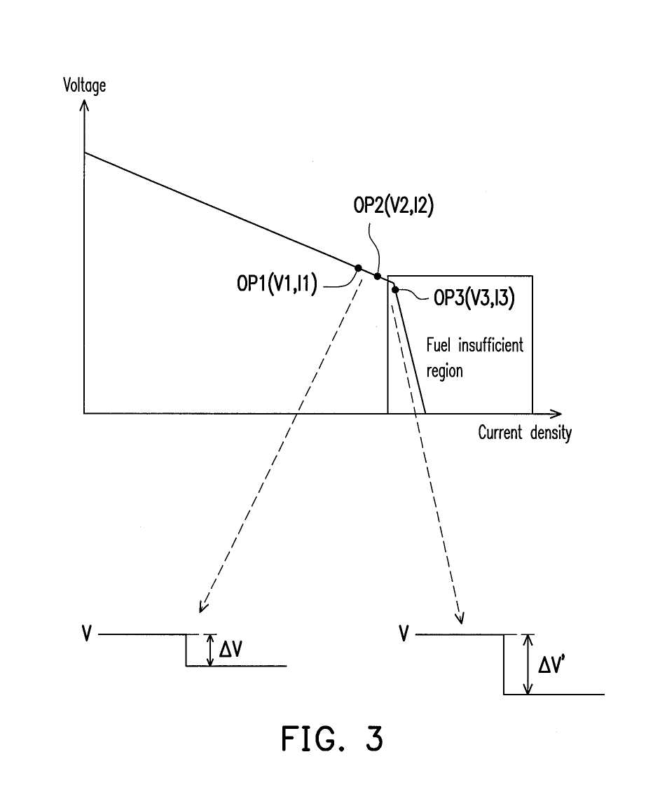

### DETAILED DESCRIPTION OF DISCLOSED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Moreover, wherever possible, like reference numerals in the drawings denote like devices/elements/steps.

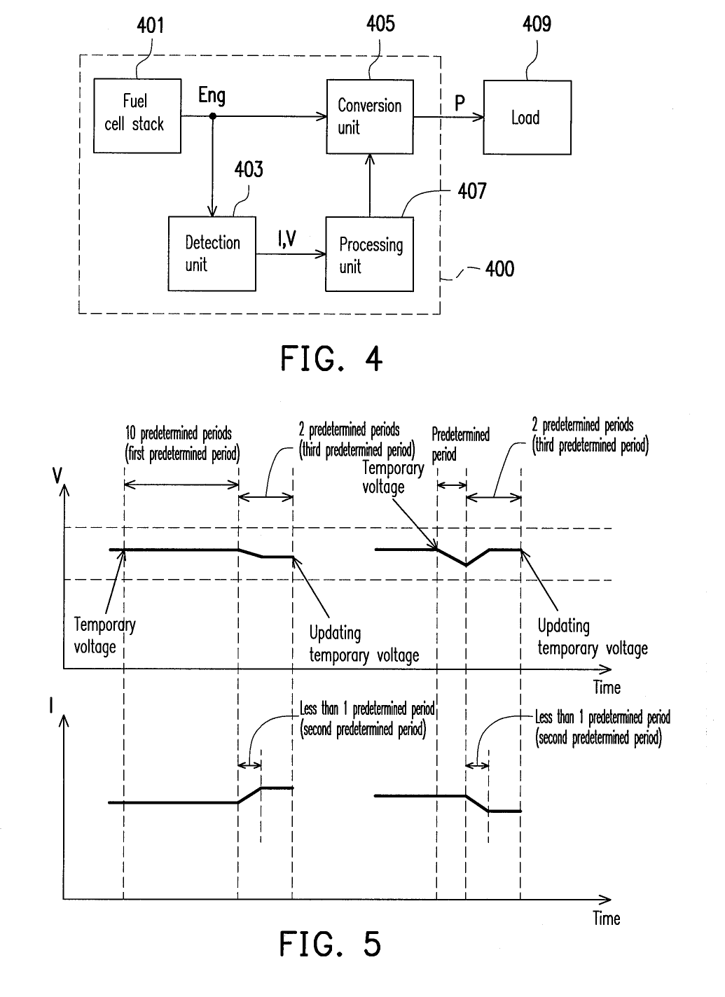

FIG. 4 is a block diagram of a fuel cell system 400 according to an embodiment of the invention. Referring to FIG. 4, the fuel cell system 400 includes a fuel cell stack 401, a detection unit 403, a conversion unit 405, and a processing unit 407. In the present embodiment, the fuel cell stack 401 may carry out a chemical reaction to output electric energy Eng. For example, the fuel cell stack 401 could be a proton exchange membrane fuel cell stack (PEMFC stack) or a direct methanol fuel cell stack (DMFC stack).

However, regardless of the PEMFC stack or the DMFC stack, both of them are belonged to a low-temperature start-up fuel cell using a proton exchange membrane for implementing a proton conduction mechanism. An operation principle of the PEMFC is as follows. Hydrogen has an oxidation reaction at an anode catalyst layer to generate hydrogen ions (H⁺) and electrons (e⁻) (PEMFC principle), or methanol and water have an oxidation reaction at the anode catalyst layer to generate hydrogen ions (H⁺), carbon dioxide (CO₂) and electrons (e⁻) (DMFC principle), where the hydrogen ions are transmitted to a cathode through the proton exchange membrane, and the electrons are transmitted to a load through an external circuit and then transmitted to the cathode. Now, the oxide supplied to the cathode and the hydrogen ions and the electrons may have a reduction reaction at a cathode catalyst layer to generate water.

The detection unit 403 is coupled to the fuel cell stack 401 for detecting an output voltage V and an output current I of the fuel cell stack 401. The conversion unit 405 (for example, a direct current (DC)-direct current (DC) converter, though the invention is not limited thereto) is coupled to the fuel cell stack 401 for converting the output voltage V and the output current I of the fuel cell stack 401, so as to provide power P to a load 409 (for example, an electronic device) for utilization.

The processing unit 407 is coupled to the detection unit 403 and the conversion unit 405 for determining whether the output voltage V of the fuel cell stack 401 is greater than or equal to a temporary voltage (Vₜₑₘₚ) during a first predetermined period (for example, 10 predetermined periods (10×T_{period}), though the invention is not limited thereto).

If yes (e.g., the output voltage V of the fuel cell stack 401 is greater than or equal to the temporary voltage during the 10 predetermined periods), the processing unit 407 controls the conversion unit 405 to indirectly and progressively increase the output current I of the fuel cell stack 401 during a second predetermined period (for example, one predetermined period (1×T_{period}), though the invention is not limited thereto) (e.g. increases the output current I of the fuel cell stack 401 by controlling the conversion unit 405, so as to increase a current of the power supplied to the load 409). In this case, it represents that an internal hydrogen flow of the fuel cell stack 401 is sufficient.

If not (e.g., the output voltage V of the fuel cell stack 401 is smaller than the temporary voltage during the 10 predetermined periods), when a variation degree of the output voltage V of the fuel cell stack 401 is greater than a predetermined value (which could be determined according to an actual design requirement) (which could be interpreted as ΔV′ of the related art), the processing unit 407 controls the conversion unit 405 to indirectly and progressively decrease the output current I of the fuel cell stack 401 during the second predetermined period (e.g. decreases the output current I of the fuel cell stack 401 by controlling the conversion unit 405, so as to decrease the current of the power supplied to the load 409). In this case, it represents that the internal hydrogen flow of the fuel cell stack 401 is probably insufficient. However, if the variation degree of the output voltage V of the fuel cell stack 401 is smaller than the predetermined value (which could be interpreted as ΔV the related art), it is probably disturbed by external environment, and the internal hydrogen flow of the fuel cell stack 401 is probably still sufficient. Therefore, the processing unit 407 re-determines the output voltage V of the fuel cell stack 401 other than immediately controlling the conversion unit 405 to indirectly and progressively decrease the output current I of the fuel cell stack 401.

Moreover, the processing unit 407 controls the conversion unit 405 to indirectly change the output voltage V of the fuel cell stack 401 in response to progressive increasing or progressive decreasing of the output current I of the fuel cell stack 401 (e.g. decreases the output voltage V of the fuel cell stack 401 by controlling the conversion unit 405), and updates the temporary voltage to the changed output voltage V after a third predetermined period (for example, two predetermined periods (2×T_{period}) though the invention is not limited thereto). In the embodiment, the first predetermined period could be greater than the second predetermined period and the third predetermined period, and the third predetermined period could be greater than the second predetermined period, though the invention is not limited thereto, which could be determined according to an actual design requirement.

According to the above descriptions, FIG. 5 is a schematic diagram illustrating determination and update processes of the processing unit 407 according to an embodiment of the invention. Referring to FIG. 4 and FIG. 5, when the processing unit 407 determines that the output voltage V of the fuel cell stack 401 is greater than or equal to the temporary voltage during the 10 predetermined periods, it represents that the internal hydrogen flow of the fuel cell stack 401 is sufficient, so that the processing unit 407 controls the conversion unit 405 to indirectly and progressively increase the output current I of the fuel cell stack 401 during one predetermined period. In this way, the output voltage V of the fuel cell stack 401 is accordingly decreased. Then, the processing unit 407 updates the temporary voltage to the changed output voltage V during two predetermined periods after 10 predetermined periods (for avoiding error determining a fuel supplying capability).

On the other hand, when the processing unit 407 determines that the output voltage V of the fuel cell stack 401 is lower than the temporary voltage during a certain one of the 10 predetermined periods, and when the variation degree of the output voltage V of the fuel cell stack 401 is greater than the predetermined value, the processing unit 407 controls the conversion unit 405 to indirectly and progressively decrease the output current I of the fuel cell stack 401 during one predetermined period, so as to avoid damage of the fuel cell stack 401 due to rapid decline of the output voltage V of the fuel cell stack 401. In this way, the output voltage V of the fuel cell stack 410 is accordingly increased. Then, the processing unit 407 updates the temporary voltage to the changed output voltage V during two predetermined periods after the predetermine period when the output voltage V of the fuel cell stack 401 has a great variation. The fuel cell stack 401 could stably operate, and could be maintained to highest performance/power efficiency.

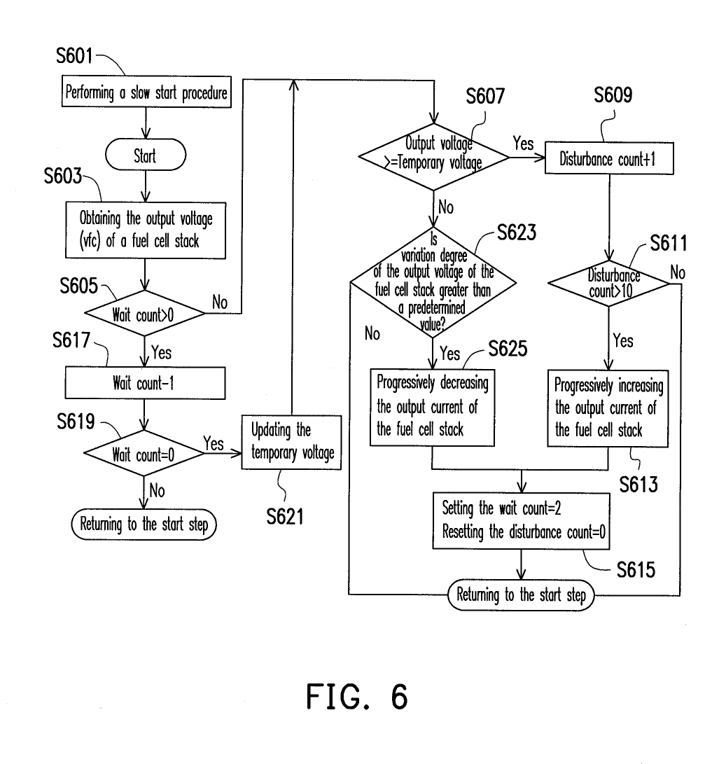

According to the above disclosure, FIG. 6 is a flowchart illustrating a method for controlling a fuel cell system according to an embodiment of the invention. The method of the embodiment includes following steps.

Before the fuel cell stack of the fuel cell system formally operates, a slow start procedure is performed (step S601) to make the fuel cell stack suitable for operation, namely, waiting for sufficient fuel to enter flow channels of the fuel cell stack and wet the fuel cell stack, and increasing a temperature of the fuel cell stack to a degree suitable for operation. After the slow start procedure is performed, the fuel cell stack starts to operate.

After the fuel cell stack starts to operate, an output voltage of the fuel cell stack is obtained (step S603).

After the output voltage of the fuel cell stack is obtained, it is determined whether a wait count is greater than 0 (step S605).

It is assumed that the wait count is equal to 0. Therefore, it is determined whether the output voltage of the fuel cell stack is greater than or equal to the temporary voltage during the first predetermined period. In detail, in the step S607, it is determined whether the output voltage of the fuel cell stack is greater than or equal to the temporary voltage. If yes, a disturbance count is added by 1 (step S609), and then it is determined whether the disturbance count is greater than 10 (corresponding to the 10 predetermined periods of the aforementioned embodiment, e.g. the first predetermined period) (step S611). If the disturbance count is not greater than 10, the start step is returned until the disturbance count is greater than 10.

Therefore, the output voltage of the fuel cell stack is obtained 10 es at different time points, and each time that the output voltage is obtained, it is compared to the temporary voltage. If the 10 obtained output voltages are all greater than or equal to the temporary voltage, the output current (Ifc) of the fuel cell stack is progressively increased during the second predetermined period (corresponding to the one predetermined period of the aforementioned embodiment) (step S613).

In response to the progressive increasing of the output current of the fuel cell stack, the output voltage of the fuel cell stack is accordingly changed (due to a characteristic of the fuel cell stack). In this way, the temporary voltage is updated after the third predetermined period. In detail, after the output current of the fuel cell stack is progressively increased, the wait count is set to 2 (corresponding to the two predetermined periods of the aforementioned embodiment, e.g. the third predetermined period), and the disturbance count is reset to 0 (step S615).

After setting the wait count and resetting the disturbance count, it is returned to the start step for re-obtaining the output voltage of the fuel cell stack (step S603), and then it is determined whether the wait count is greater than 0 (step S605). Since the wait count is 2, it is subtracted by 1 (step S617), and then it is determined whether the wait count is equal to 0 (step S619). If the wait count is not equal to 0, it is returned to the start step until the wait count is equal to 0. Once the wait count is equal to 0, the temporary voltage is updated to the changed output voltage corresponding to the progressively increased output current (step S621), and the output current of the fuel cell stack is adjusted again for a next cycle.

On the other hand, in the step S607, if the output voltage of the fuel cell stack is determined to be smaller than the temporary voltage, it is further determined whether a variation degree of the output voltage of the fuel cell stack is greater than a predetermined value (step S623). If the variation degree of the output voltage of the fuel cell stack is less than the predetermined value, it is probably disturbed by external environment, and the internal hydrogen flow of the fuel cell stack is probably still sufficient. Therefore, it is returned to the start step to re-obtain the output voltage of the fuel cell stack for determination. However, if the variation degree of the output voltage of the fuel cell stack is greater than the predetermined value, the output current of the fuel cell stack is progressively decreased during the second predetermined period (corresponding to the one predetermined period of the aforementioned embodiment) (step S625).

In response to the progressive decreasing of the output current of the fuel cell stack, the output voltage of the fuel cell stack is accordingly changed (due to the characteristic of the fuel cell stack). In this way, the temporary voltage is updated again (e.g. the temporary voltage is updated to the changed output voltage corresponding to the progressively decreased output current), and the output current of the fuel cell stack is adjusted again for a next cycle.

Similarly, in the embodiment, the first predetermined period could be greater than the second predetermined period and the third predetermined period, and the third predetermined period could be greater than the second predetermined period, though the invention is not limited thereto, which could be determined according to an actual design requirement.

In summary, according to the embodiments of the invention, at least one of the following advantages could be implemented:
1. The output current of the fuel cell stack is dynamically adjusted, which is adapted to a fuel cell system having a varied fuel supplying environment (e.g. a varied fuel flow).
2. Presetting of a fixed operating point is unnecessary, which is adapted to the fuel cell stacks with different aging degrees.
3. A stepped adjustment method is used to adjust the output current of the fuel cell stack to smooth a variation degree of the output voltage and the output current of the fuel cell stack, so as to improve a lifetime of the fuel cell stack.
4. The variation of the output voltage of the fuel cell stack is controlled to avoid the fuel cell stack entering a fuel insufficient region, so as to avoid immense decline of the output voltage of the fuel cell stack to cause a damage of the fuel cell stack.
5. The output current of the fuel cell stack is adjusted for a next cycle only when the fuel entering the fuel cell stack is stable, so that the fuel cell system will not error determine a fuel supplying status to avoid immense decline of the output voltage of the fuel cell stack that causes a damage of the fuel cell stack.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A method for controlling a fuel cell system, comprising:
determining whether an output voltage of a fuel cell stack in the fuel cell system is greater than or equal to a temporary voltage during a first predetermined period;
if yes, progressively increasing an output current of the fuel cell stack during a second predetermined period;
if not, progressively decreasing the output current of the fuel cell stack during the second predetermined period when a variation degree of the output voltage of the fuel cell stack is greater than a predetermined value; and
changing the output voltage of the fuel cell stack in response to progressive increasing or progressive decreasing of the output current, and updating the temporary voltage to the changed output voltage after a third predetermined period.

2. The method for controlling the fuel cell system as claimed in claim 1, wherein before the step of determining whether the output voltage of the fuel cell stack in the fuel cell system is greater than or equal to the temporary voltage during the first predetermined period, the method further comprises:
obtaining the output voltage of the fuel cell stack.

3. The method for controlling the fuel cell system as claimed in claim 2, wherein before the step of obtaining the output voltage of the fuel cell stack, the method further comprises:
performing a slow start procedure to make the fuel cell stack suitable for operation.

4. The method for controlling the fuel cell system as claimed in claim 2, wherein when the variation degree is smaller than the predetermined value, the output voltage of the fuel cell stack is re-obtained for determination.

5. The method for controlling the fuel cell system as claimed in claim 1, wherein the first predetermined period is greater than the second predetermined period and the third predetermined period, and the third predetermined period is greater than the second predetermined period.

6. A fuel cell system, comprising:
a fuel cell stack, for carrying out a chemical reaction to produce electric energy;
a detection unit, coupled to the fuel cell stack, for detecting an output voltage and an output current of the fuel cell stack;
a conversion unit, coupled to the fuel cell stack, for converting the output voltage and the output current of the fuel cell stack; and
a processing unit, coupled to the detection unit and the conversion unit, for determining whether the output voltage of the fuel cell stack is greater than or equal to a temporary voltage during a first predetermined period, wherein if yes, the processing unit controls the conversion unit to indirectly and progressively increase the output current of the fuel cell stack during a second predetermined period, and if not, when a variation degree of the output voltage of the fuel cell stack is greater than a predetermined value, the processing unit controls the conversion unit to indirectly and progressively decrease the output current of the fuel cell stack during the second predetermined period, and the processing unit controls the conversion unit to indirectly change the output voltage of the fuel cell stack in response to progressive increasing or progressive decreasing of the output current of the fuel cell stack, and updates the temporary voltage to the changed output voltage after a third predetermined period.

7. The fuel cell system as claimed in claim 6, wherein when the variation degree is smaller than the predetermined value, the processing unit re-determines whether the output voltage of the fuel cell stack is greater than or equal to the temporary voltage of the fuel cell stack during the first predetermined period.

8. The fuel cell system as claimed in claim 6, wherein the first predetermined period is greater than the second predetermined period and the third predetermined period, and the third predetermined period is greater than the second predetermined period.

9. The fuel cell system as claimed in claim 6, wherein the fuel cell stack is a proton exchange membrane fuel cell stack (PEMFC stack).
